(19) United States
(12) Patent Application Publication
(10) Pub. No.: US 2016/0355101 A1
(43) Pub. Date: Dec. 8, 2016

(54) METHOD FOR CALCULATING HYDROGEN CONSUMPTION AMOUNT OF FUEL CELL VEHICLE

(71) Applicant: Hyundai Motor Company, Seoul (KR)

(72) Inventors: Yu Han Kim, Yongin (KR); Yong Gyu Noh, Suwon (KR)

(21) Appl. No.: 14/946,917

(22) Filed: Nov. 20, 2015

(30) Foreign Application Priority Data
Jun. 3, 2015 (KR) 10-2015-0078422

(51) Int. Cl. B60L 11/18; H01M 8/04223; H01M 8/0438; H01M 8/04746; H01M 8/04082; H01M 8/2457

(52) U.S. Cl. CPC B60L 11/1881; H01M 8/04201; H01M 8/2457; H01M 8/04388; H01M 8/04753; H01M 8/04231; H01M 2250/20

(57) ABSTRACT

A method for calculating an amount of hydrogen consumed by a fuel cell vehicle, in order to improve the accuracy of fuel efficiency calculation when the fuel cell vehicle travels under real-world conditions, includes: calculating a hydrogen consumption amount via integration of stack current generated in a fuel cell stack, calculating an amount of unreacted hydrogen purged from the fuel cell stack, and calculating a final hydrogen consumption amount by adding the purged amount of hydrogen to the hydrogen consumption amount calculated via the stack current integration.

### CROSS-REFERENCE TO RELATED APPLICATION

This application claims under 35 U.S.C. §119(a) the benefit of priority to Korean Patent Application No. 10-2015-0078422 filed on Jun. 3, 2015, the entire contents of which are incorporated herein by reference.

### BACKGROUND

(a) Technical Field

The present invention relates to a method for calculating an amount of hydrogen consumed by a fuel cell vehicle, more particularly, to a method for calculating the amount of hydrogen consumed by the fuel cell vehicle, which may improve accuracy of a fuel efficiency calculation via the accurate calculation of the amount of hydrogen consumed when the fuel cell vehicle travels under real-world conditions.

(b) Description of the Related Art

When a fuel cell vehicle travels under real-world conditions, it is necessary to calculate the amount of hydrogen consumed, in order to calculate the fuel efficiency of the vehicle. At present, real-world fuel efficiency is calculated using, for example, fuel cell stack current integration, hydrogen flow rate measurement, hydrogen tank weight measurement, and hydrogen tank temperature/pressure measurement. Stack current integration and hydrogen tank temperature/pressure measurement are mainly used.

Hydrogen tank weight measurement involves measuring the weight difference of a hydrogen tank, in which hydrogen is stored, before and after testing, in order to calculate the amount of hydrogen consumed. This ensures high precision, but cannot be applied to a real vehicle.

Hydrogen tank temperature/pressure measurement involves measuring the temperature and pressure of a hydrogen tank before and after traveling, in order to calculate the amount of hydrogen consumed. This may be utilized to calculate fuel efficiency in the real world, but requires time for the stabilization of temperature and pressure, thus making it difficult to utilize for calculating the fuel efficiency of real-world travel.

Hydrogen flow rate measurement requires a separate flow meter, and exhibits low precision in the measurement of the flow rate of gas despite the presence of the flow meter, thereby being difficult to utilize to calculate the fuel efficiency of real-world travel.

Stack current integration involves integrating stack current, i.e., the current generated in a fuel cell stack. This may be applied to calculate the fuel efficiency of real-world travel, but does not consider hydrogen other than the hydrogen used to generate current (for example, unreacted residual hydrogen purged from the stack for electricity generation), and suffers from low accuracy in the calculation of the amount of hydrogen that is consumed.

Stack current integration for the calculation of the amount of hydrogen that is consumed according to the related art will be described in more detail with reference to FIGS. 1 and 2.

As illustrated in FIG. 1 (RELATED ART), a hydrogen supply system to supply hydrogen to a fuel cell stack includes a hydrogen tank 10, a hydrogen pressure control valve 12 to control the pressure of hydrogen from the hydrogen tank 10, and an ejector 14 to pressurize and direct hydrogen to a fuel cell stack 16. FIG. 2 (RELATED ART) is a flow diagram illustrating the steps for calculating the amount of hydrogen that is consumed by using the hydrogen supply system depicted in FIG. 1.

The fuel cell stack implements a known electricity generation operation using hydrogen supplied from the hydrogen supply system and air (oxygen) supplied from a separate air supply system, and generated stack current is supplied to an electrical load (e.g., a traveling motor or a battery) in a chargeable/dischargeable manner.

At this time, a current sensor is used to measure the stack current. The amount of hydrogen that is consumed is calculated via the integration of the measured stack current.

However, as described above, stack current integration does not consider hydrogen other than the hydrogen used to generate current (for example, unreacted residual hydrogen purged from the stack for electricity generation), thus having low accuracy in the calculation of the amount of hydrogen that is consumed and, consequently, lowering the accuracy of a fuel efficiency calculation.

### SUMMARY

The present invention provides a method for calculating the amount of hydrogen consumed by a fuel cell vehicle in which the purged amount of hydrogen is calculated using the trailing end pressure of a hydrogen pressure control valve, which adjusts the pressure of hydrogen from a hydrogen tank, or the PWM duty of the hydrogen pressure control valve, and the calculated purged amount of hydrogen is added to the amount of hydrogen that is consumed, calculated by stack current integration, thereby improving the accuracy of fuel efficiency calculation via the accurate calculation of the amount of hydrogen consumed when the fuel cell vehicle travels under real-world conditions.

In one aspect, the present invention provides a method for calculating the amount of hydrogen consumed by a fuel cell vehicle, the method including calculating a hydrogen consumption amount via integration of stack current generated in a fuel cell stack, calculating an amount of unreacted hydrogen purged from the fuel cell stack, and calculating a final hydrogen consumption amount by adding the amount of the purged hydrogen to the hydrogen consumption amount calculated via the stack current integration.

In a preferred embodiment, the method may further include making a map table of the amount of the purged hydrogen.

In another preferred embodiment, the amount of the purged hydrogen may be acquired by integrating a value calculated using a PWM duty of a hydrogen pressure control valve configured to control pressure of hydrogen from a hydrogen tank.

In still another preferred embodiment, the amount of the purged hydrogen may be acquired by integrating a value calculated using a trailing end pressure of a hydrogen pressure control valve configured to control pressure of hydrogen from a hydrogen tank.

A non-transitory computer readable medium containing program instructions executed by a processor includes: program instructions that calculate a hydrogen consumption amount via integration of stack current generated in a fuel cell stack; program instructions that calculate an amount of unreacted hydrogen purged from the fuel cell stack; and program instructions that calculate a final hydrogen consumption amount by adding the purged amount of hydrogen to the hydrogen consumption amount calculated via the stack current integration.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIGS. 1 and 2 (RELATED ART) are views illustrating a method for calculating the amount of hydrogen consumed by a fuel cell vehicle according to the related art;

FIGS. 3 and 4 are views illustrating a method for calculating the amount of hydrogen consumed by a fuel cell vehicle according to the present invention; and

FIG. 5 is a graph comparing the hydrogen consumption amount calculated by the method for calculating the amount of hydrogen consumed by a fuel cell vehicle according to the present invention with the actually measured hydrogen consumption amount.

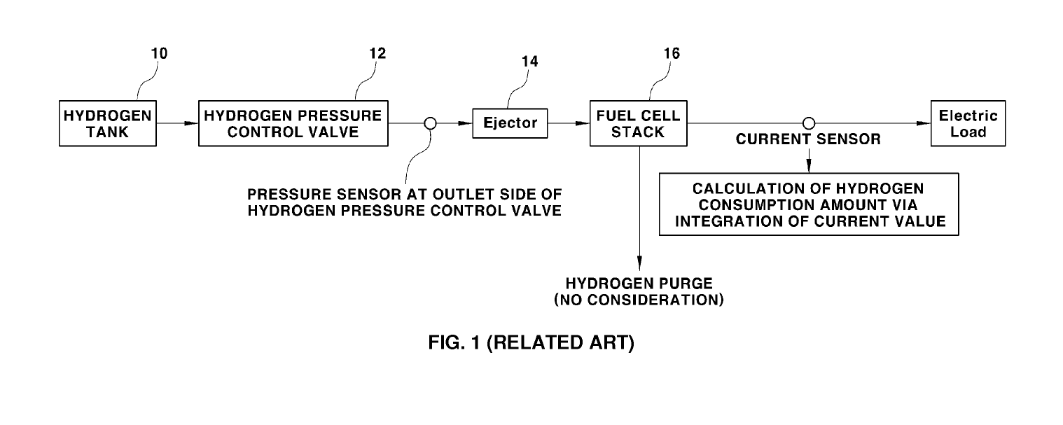

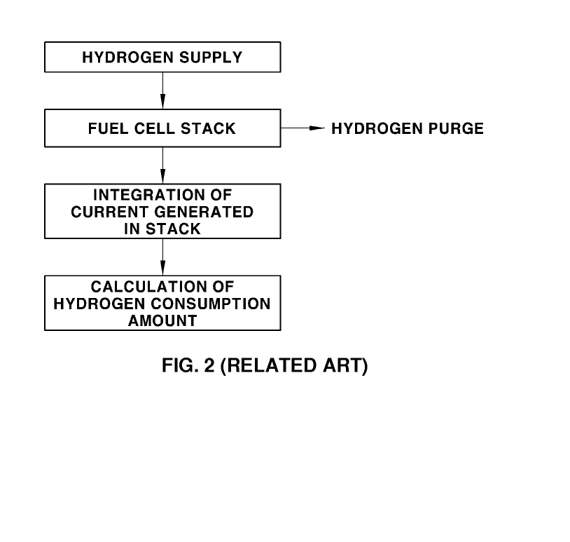

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

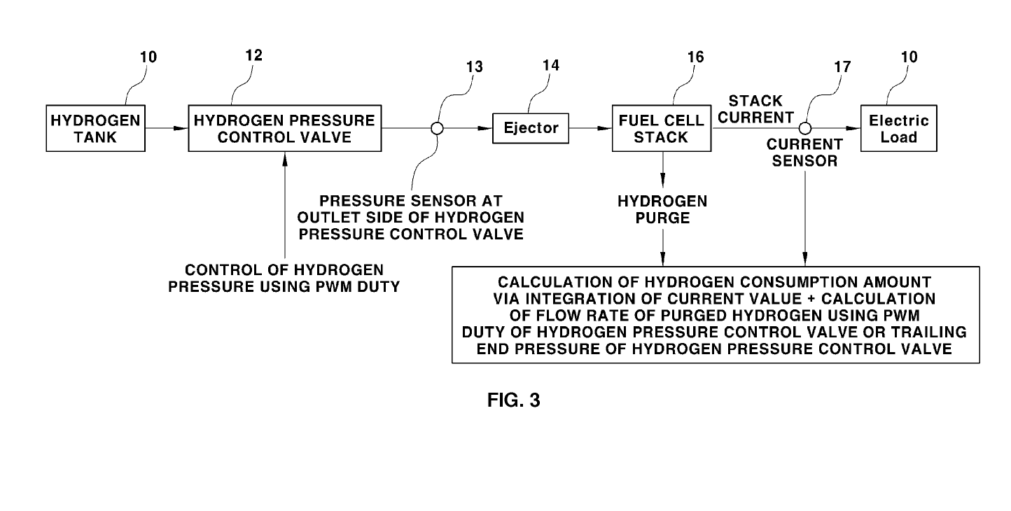

Referring to FIG. 3, a hydrogen supply system to supply hydrogen to a fuel cell stack includes a hydrogen tank 10, a hydrogen pressure control valve 12 to control the pressure of hydrogen from the hydrogen tank 10, and an ejector 14 to pressurize and direct hydrogen to a fuel cell stack 16. A pressure sensor 13 to measure the hydrogen pressure is disposed at the outlet side of the hydrogen pressure control valve 12, and a current sensor 17 to measure stack current is disposed at the fuel cell stack 16.

With this configuration, the fuel cell stack implements a known electricity generation operation using hydrogen supplied from the hydrogen supply system and air (oxygen) supplied from a separate air supply system, and generated stack current is supplied to an electrical load (e.g., a traveling motor or a battery) in a chargeable/dischargeable manner.

At this time, the current sensor 17 measures the stack current. The amount of hydrogen that is consumed is calculated via the integration of the measured stack current.

Here, in the case where the amount of unreacted hydrogen purged from the fuel cell stack 16 is not considered, the final hydrogen consumption amount calculated by stack current integration may be not accurate.

Therefore, the present invention focuses on calculating the final hydrogen consumption amount by adding the amount of the purged hydrogen to the hydrogen consumption amount calculated via stack current integration, thereby realizing more accurate calculation of the hydrogen consumption amount.

To this end, the hydrogen consumption amount is primarily calculated via the integration of current generated in the fuel cell stack, and the hydrogen purge amount, i.e., the amount of unreacted hydrogen purged from the fuel cell stack, is secondarily calculated using the PWM duty of the hydrogen pressure control valve or the trailing end pressure of the hydrogen pressure control valve. Then, as the primarily calculated hydrogen consumption amount and the secondarily calculated hydrogen purge amount are added to each other, the final hydrogen consumption amount in consideration of the hydrogen purge amount is calculated.

Typically, as a result of measuring the flow rate of hydrogen based on the PWM duty of the hydrogen pressure control valve and the trailing end pressure of the hydrogen pressure control valve through the installation of a hydrogen flow meter, the hydrogen flow rate is measured as being proportional to the PWM duty and also being proportional to the trailing end pressure of the hydrogen pressure control valve. In this way, the hydrogen consumption amount may be calculated from the PWM duty or the trailing end pressure of the hydrogen pressure control valve.

That is, the amount of hydrogen purged from the stack may be calculated based on that the flow rate of hydrogen increases as the PWM duty for the hydrogen pressure control of the hydrogen pressure control valve increases and also increases as the trailing end pressure of the hydrogen pressure control valve increases.

The hydrogen purge amount, which varies depending on the PWM duty of the hydrogen pressure control valve or the trailing end pressure of the hydrogen pressure control valve, is calculated and represented as a map table.

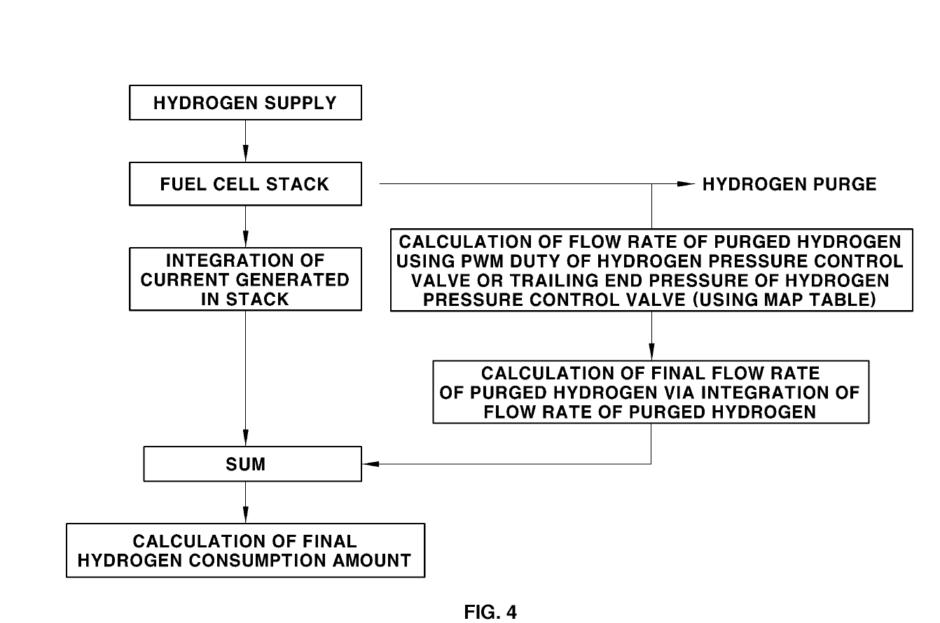

Here, the method for calculating the amount of hydrogen consumed by the fuel cell vehicle according to the present invention will be described in sequence with reference to FIG. 4.

First, the hydrogen consumption amount is primarily calculated via the integration of current generated from the fuel cell stack.

Subsequently, the hydrogen purge amount, i.e., the amount of unreacted hydrogen purged from the fuel cell stack, is secondarily calculated using the PWM duty of the hydrogen pressure control valve or the trailing end pressure of the hydrogen pressure control valve.

Preferably, after taking the hydrogen purge amount, which varies depending on the PWM duty of the hydrogen pressure control valve or the trailing end pressure of the hydrogen pressure control valve, from a map table, the taken hydrogen purge amount is subjected to integration, so as to implement secondary calculation for the hydrogen purge amount.

Subsequently, by adding the primarily calculated hydrogen consumption amount and the secondarily calculated hydrogen purge amount to each other, the final hydrogen consumption amount is calculated in consideration of the hydrogen purge amount.

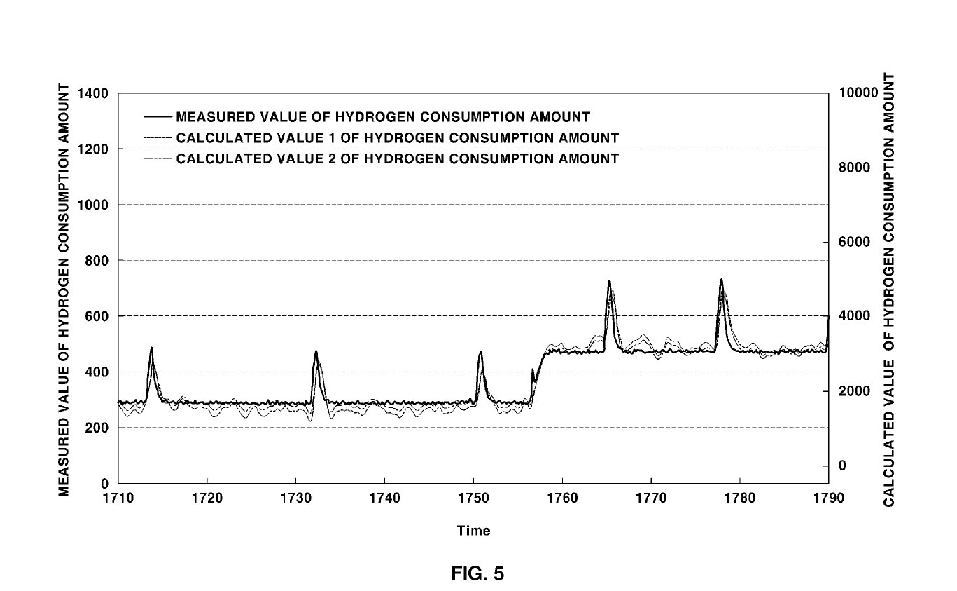

In a test example of the present invention, the amount of hydrogen consumed by a vehicle traveling in the real world was calculated by adding the primarily calculated hydrogen consumption amount and the secondarily calculated hydrogen purge amount, and the resulting calculated value was compared with the amount of hydrogen that was actually consumed (the actual measured value of the amount of hydrogen consumed) by an experimental vehicle measured using conventional fuel efficiency measurement equipment. As a result, it was found that the hydrogen consumption amount calculated by the method of the present invention was similar to the hydrogen consumption amount measured for the experimental vehicle as illustrated in FIG. 5.

In addition, a test, in which the hydrogen consumption amount was calculated using existing hydrogen tank weight measurement and stack current integration and compared with the hydrogen consumption amount calculated by the method of the present invention, was implemented. The test results are provided in Table 1 below.

TABLE 1

| | | Hydrogen |
|---|---|---|
| | | Consumption |
| Method of Calculation of | Hydrogen Consumption | Amount (g) |
| Hydrogen Consumption | Amount (g) Using Existing | Using Present |
| Amount | Method | Invention |
| \textcircled{1} Hydrogen Tank | Approx. 140.0 | Approx. 140.0 |
| Weight Measurement | | |
| \textcircled{2} Stack Current | Appox. 120.0 | Approx. 120.0 |
| Integration | | |
| \textcircled{3} PWM Duty or | — | 6.0 or more |
| Pressure Integration | | |
| Accuracy (\textcircled{2} + \textcircled{3}/\textcircled{1}) | 85% | 90% |

As can be seen from Table 1, the accuracy of the hydrogen consumption amount calculated using stack current integration was 85%, whereas the accuracy of the hydrogen consumption amount calculated according to the present invention was 90%, representing an improvement of about 5%.

As is apparent from the above description, the present invention provides effects as follows.

According to the present invention, the amount of hydrogen purged from a fuel cell stack is calculated using the trailing end pressure of a hydrogen pressure control valve, which adjusts the pressure of hydrogen from a hydrogen tank, or the PWM duty of the hydrogen pressure control valve, and the calculated purged amount of hydrogen is added to the amount of hydrogen that is consumed, calculated by stack current integration. Thereby, the present invention has the effects of enabling the accurate calculation of the amount of hydrogen consumed when a fuel cell vehicle travels under real-world conditions, which may improve the calculation accuracy of the time when the calculated amount of hydrogen that is consumed is displayed on a cluster and the average fuel efficiency and may improve the accuracy of analysis of vehicle fuel efficiency data.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for calculating an amount of hydrogen consumed by a fuel cell vehicle, the method comprising:
calculating a hydrogen consumption amount via integration of stack current generated in a fuel cell stack;
calculating an amount of unreacted hydrogen purged from the fuel cell stack; and
calculating a final hydrogen consumption amount by adding the purged amount of hydrogen to the hydrogen consumption amount calculated via the stack current integration.

2. The method of claim 1, further comprising making a map table of the purged amount of hydrogen.

3. The method of claim 1, wherein the amount of the purged hydrogen is acquired by integrating a value calculated using a PWM duty of a hydrogen pressure control valve configured to control pressure of hydrogen from a hydrogen tank.

4. The method of claim 2, wherein the amount of the purged hydrogen is acquired by integrating a value calculated using a PWM duty of a hydrogen pressure control valve configured to control pressure of hydrogen from a hydrogen tank.

5. The method of claim 1, wherein the amount of the purged hydrogen is acquired by integrating a value calculated using a trailing end pressure of a hydrogen pressure control valve configured to control pressure of hydrogen from a hydrogen tank.

6. The method of claim 2, wherein the amount of the purged hydrogen is acquired by integrating a value calculated using a trailing end pressure of a hydrogen pressure control valve configured to control pressure of hydrogen from a hydrogen tank.

7. A non-transitory computer readable medium containing program instructions executed by a processor, the computer readable medium comprising:
program instructions that calculate a hydrogen consumption amount via integration of stack current generated in a fuel cell stack;
program instructions that calculate an amount of unreacted hydrogen purged from the fuel cell stack; and
program instructions that calculate a final hydrogen consumption amount by adding the purged amount of hydrogen to the hydrogen consumption amount calculated via the stack current integration.
